(19) United States
(12) Patent Application Publication
(10) Pub. No.: US 2026/0264359 A1
(43) Pub. Date: Sep. 10, 2026

(54) Roll Assembly for Producing Non-Destructively Embossed Barrier Paper for Air-Tight and Water-Vapour-Tight Sealing of Packages, and Corresponding Method

(71) Applicants: Matthews International GmbH, Vreden (DE); Matthews International Corporation, Pittsburgh, PA (US)

(72) Inventors: Michael KOSCHKE, Vreden (DE); Ronny SCHLEGEL, Stadtlohn (DE)

(21) Appl. No.: 18/718,118

(22) PCT Filed: Dec. 9, 2022
(86) PCT No.: PCT/DE2022/100937

§ 371 Date: Jun. 10, 2024

(30) Foreign Application Priority Data
Dec. 15, 2021 (DE) 10 2021 133 331.8

(51) Int. Cl. B31F 1/07

(52) U.S. Cl. CPC B31F 1/07; B31F 2201/0733; B31F 2201/0738; B31F 2201/0743

(57) ABSTRACT

The invention relates to a roll assembly for producing non-destructively embossed barrier paper for air-tight and water-vapor-tight sealing of cigarette packages, in particular for use as an inner liner, having: a first embossing roll; and a second embossing roll; wherein a nip is formed between the first embossing roll and the second embossing roll to feed through and emboss the barrier paper; wherein at least one of the embossing rolls has a plurality of embossing elements, the embossing elements having, on their upper face, an edge which runs around the embossing elements and has an edge radius of 1 μm to 1000 μm. The invention also relates to a method for producing non-destructively embossed barrier paper for air-tight and water vapor-tight sealing of cigarette packages, in particular for use as an inner liner.

The invention relates to a roll assembly for producing non-destructively embossed barrier paper for air-tight and water-vapor-tight sealing of packages, in particular for use as an inner liner for cigarette packages, having: a first embossing roll; and a second embossing roll; wherein a nip is formed between the first embossing roll and the second embossing roll to feed through and emboss the barrier paper; wherein at least one of the embossing rolls has a plurality of embossing elements.

For example, a cigarette package usually contains the following components. A cardboard package designed with the corresponding brand layout serves as a container for holding a plurality of cigarettes. The cigarettes are directly wrapped in an inner liner, which is located together with the cigarettes in the cardboard package. This inner liner is used in particular for the simultaneous bulk filling of the carton package with the plurality of cigarettes. The cardboard package is covered on the outside with a transparent plastic film, which serves to preserve the taste and freshness of the tobacco products. In the wake of increasing environmental awareness and an increased demand for plastic-free product packages, there is also a need in the tobacco sector for cigarette packages that contains as little plastic as possible. One solution is to transfer the function of the plastic film to the cardboard packages or the inner liner and consequently eliminate the plastic film completely. For this purpose, the cardboard packages and/or the inner liner can consist of a barrier paper which shields the cigarettes wrapped therein against external environmental influences. At the same time, as legislation becomes increasingly strict, manufacturers are being required to print warnings and shock images on cigarette and tobacco packages on an ever larger scale. This brings into focus alternative surfaces on cigarette packages on which brand-specific texts and/or symbols can be applied. However, the embossing methods known from prior art destroy the fibers and in particular the barrier layer in order to achieve a required element height on the material to be embossed. There is therefore a need for an embossing process for embossing barrier paper, particularly with regard to its use in tobacco packages.

It is therefore the object of the invention to provide a roll assembly by means of which the introduction of embossings into a barrier paper is made possible without destroying the barrier function of the barrier paper.

The object is achieved by the features of the independent claims.

Accordingly, it is provided that the embossing elements each have an edge which runs around the embossing element on their upper face with an edge radius of I um to 1000 μm. Preferably, the edges may have an edge radius of greater than 10 μm. Particularly preferably, the edges may have an edge radius of greater than 100 μm. By providing an edge radius that is not too small, destruction of the barrier layer of the barrier paper can be effectively prevented. The embossing elements can all have the same height or depth. Furthermore, the embossing elements can have a flat surface within the surrounding edge. The barrier paper can essentially have two layers, a paper layer or a base paper, which consists of paper fibers, and a lacquer layer or a sealing coating which serves to produce the barrier properties. In addition, the barrier paper can have a printing coating, which provides the barrier paper with particularly good printing properties. The barrier property can be designed to be an aroma barrier, a fat barrier, a MOSH/MOAH barrier, an oxygen barrier, an UV barrier and/or a water barrier. Furthermore, the barrier paper or in particular the barrier layer can be heat-sealable. The diameter of the embossing rolls can be up to 2 m. The width of the embossing rolls can be up to 6 m. The upper face of an embossing elevation may be provided by a surface facing substantially away from the roll surface. In the case of a stepped embossing elevation, each surface of each step of an embossing elevation within the meaning of this application can have a separate edge surrounding the respective surface. The surrounding edge can also have different radii along its length, as long as these are larger than the minimum radius required for non-destructive embossing. The upper face of a recess can be realized by a surrounding edge that is essentially at the level of the roll surface and runs around the recess. In the case of a stepped recess, each surrounding edge of each step of the recess within the meaning of this application can have a separate edge surrounding the respective recess step. The surrounding edge can also have different radii along its length, as long as these are larger than the minimum radius required for non-destructive embossing. It can further be provided that the edge surrounding an embossing elevation at the level of the roll surface or the edge surrounding a recess at the level of the recess base have a radius of 1 μm to 1000 μm. For example, the inner package may be an inner liner for a cigarette package.

It can be provided that the at least one embossing roll having the plurality of embossing elements is designed as a male die and the embossing elements extend away from the roll surface as embossing elevations. It is further conceivable that the at least one embossing roll having the plurality of embossing elements is designed as a female die and the embossing elements extend as recesses into the roll surface.

The embossing elements can all have the same height or depth. The embossing elements can alternatively have a step profile in which each step has a surrounding edge with an edge radius of greater than 1 μm to 1000 μm. The embossing elements can also have any free form, as long as a certain embossing height is not exceeded and none of the edge radii is smaller than 1 μm to 1000 μm. This can apply to embossing elevations and, analogously, to recesses.

It can also be provided that the backing roll of the embossing roll having the plurality of embossing elements has a smooth roll surface without embossing elements, wherein the roll surface of the backing roll is made of steel or of an elastic material, such as rubber or plastic.

Furthermore, it can be provided that the backing roll of the embossing roll having the plurality of embossing elevations is designed as a female die, wherein the backing roll has a plurality of recesses made in the roll surface, which are arranged complementarily to the embossing elevations extending away from the roll surface. The recesses can in particular be designed to be complementary to the embossing elevations, so that the embossing elevations can engage precisely in the respective recesses.

Furthermore, it can be provided that the backing roll of the embossing roll having the plurality of embossing elevations is designed as a male die, wherein the backing roll has a plurality of embossing elevations extending away from the roll surface, which are arranged complementarily to the recesses extending into the roll surface. The embossing elevations can in particular be designed to be complementary to the embossing elevations, so that the embossing elevations can engage precisely in the respective recesses.

It can be provided that the embossing height and/or embossing depth of the embossing elements is up to 200 μm. It can be provided that the embossing height and/or embossing depth of the embossing elements is up to 150 μm. It can be provided that the embossing height and/or embossing depth of the embossing elements is up to 100 μm. The embossing elements can have a flat upper face. The embossing elements can also have a structured surface with a highest elevation or deepest recess of up to 200 μm. The embossing elements can in particular have flanks extending perpendicularly away from the roll surface. In the case of recesses, these can also have side walls extending vertically into the roll surface. The side walls of the recesses and/or the flanks of the embossing elevations can further be angled so that the flanks of the embossing elevations have an angle of greater than 90° with respect to the roll surface and the side walls of the recesses have an angle of less than 90° with respect to the roll surface. It can also be provided that the embossing elements are attached to a

In addition, the first and/or the second embossing roll can have an average roughness Rz of 1 to 50 μm.

It can be provided that the embossing elements each have a length of greater than 0.1 mm in an axial direction of the embossing roll. It can also be provided that the embossing elements each have a width of more than 0.1 mm in a circumferential direction of the embossing roll. It can be provided that the embossing elements each have a length of greater than 0,2 mm in an axial direction of the embossing roll. It can also be provided that the embossing elements each have a width of greater than 0,2 mm in a circumferential direction of the embossing roll. Particularly preferably, it can be provided that the embossing elements each have a length of greater than 0,3 mm in an axial direction of the embossing roll. It can also be provided that the embossing elements each have a width of greater than 0,3 mm in a circumferential direction of the embossing roll. The embossing elements can be circular, rectangular, oval, etc. or can also have more complex shapes such as letters, symbols or trademarks. By providing embossing elements with a minimum size, the surface pressure applied to the material to be embossed can be adjusted and preconfigured to a material-dependent maximum value.

The invention further relates to a method for producing non-destructively embossed barrier paper for air-and water vapor-tight sealing of packages, in particular for use as inner package, with a roll assembly according to any one of claims 1 to 10, comprising the steps:
feeding a barrier paper web through the nip of the roll assembly;
forming an embossed pattern in the barrier paper as the barrier paper web is fed through the nip.

The method may provide for the barrier paper to have a fiber thickness of up to 100 μm. Furthermore, it can be provided that the barrier paper has a fiber length of up to 3 mm.

The paper thickness of the barrier paper can be between 20 μm and 500 μm. It may further be provided that the barrier paper has a weight between 10 GSM and 800 GSM.

In particular, it can be provided that the embossed pattern has an embossing height of up to 50 μm. In addition to providing a minimum radius at the embossed edges and realizing a minimum size of the embossing elements, providing a maximum embossing height can be an effective measure to avoid damaging the barrier function of the barrier paper. It can further be provided that the roll adjustment is provided in such a way that it corresponds exactly to the paper thickness of the barrier paper used, so that in the region of the embossing rolls, which has no embossing elements, no compression of the paper web takes place and the barrier paper is only deformed or stressed in the regions of the embossing elements. It may be intended that a barrier paper with a thicker barrier or varnish layer is used in the event that the desired embossed pattern is to have a particularly large embossing height. Accordingly, it can be provided that the thickness of the barrier layer and accordingly the roll adjustment can be set to the desired embossing height of the embossing pattern.

It can also be provided that the barrier paper is guided through the nip in such a way that the barrier layer faces away from the embossing elevations and towards the backing roll designed as a smooth roll or as a female die.

Exemplary embodiments of the invention are explained with reference to the following figures. In particular:

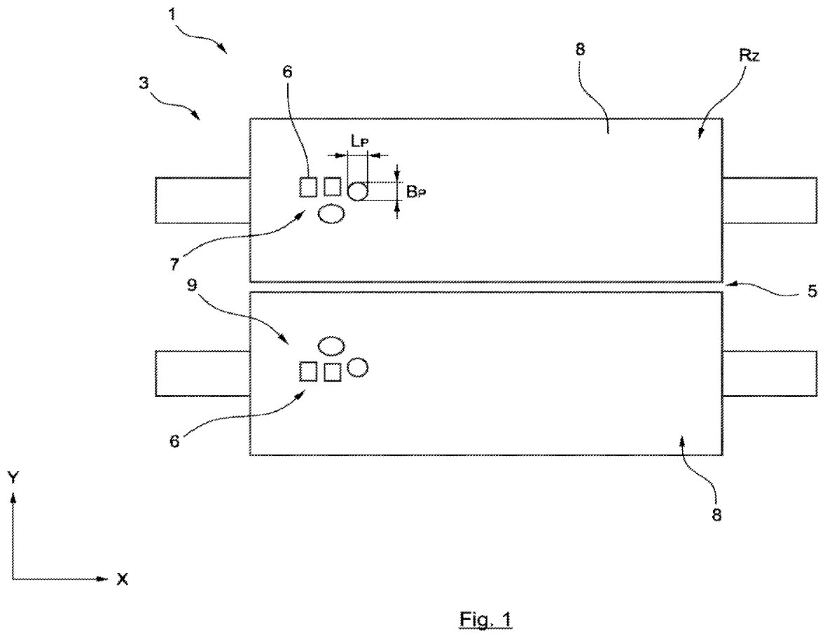

FIG. 1 shows a plan top view of an embodiment of the roll assembly according to the invention;

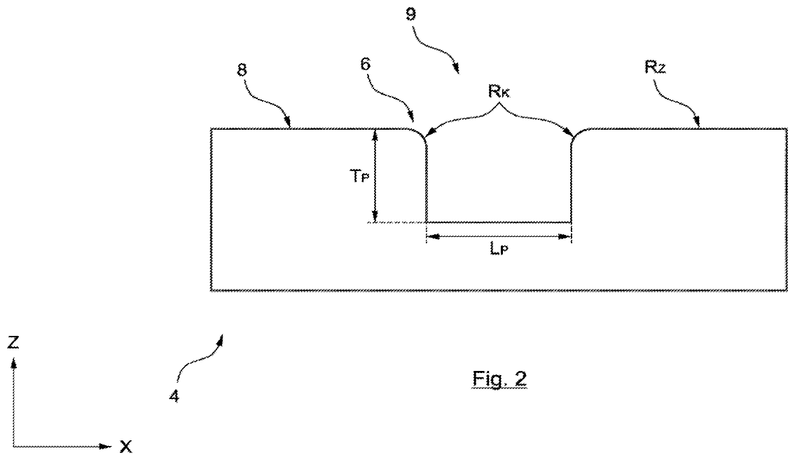

FIG. 2 shows a detailed view of a recess in an embossing roll designed as a female die;

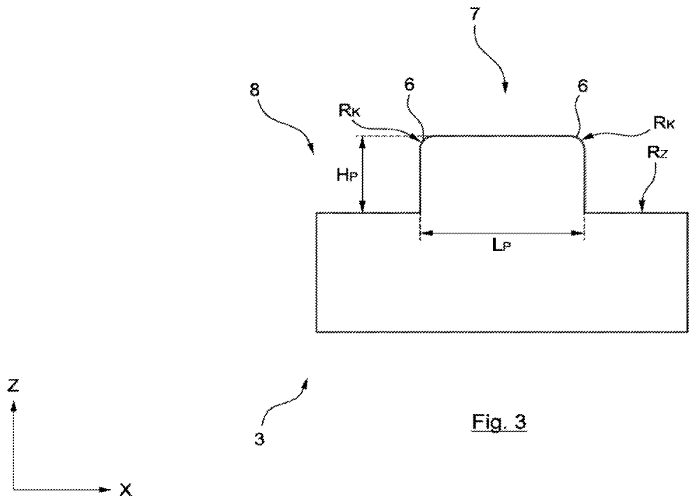

FIG. 3 shows a detailed view of an embossing elevation in an embossing roll designed as a male die;

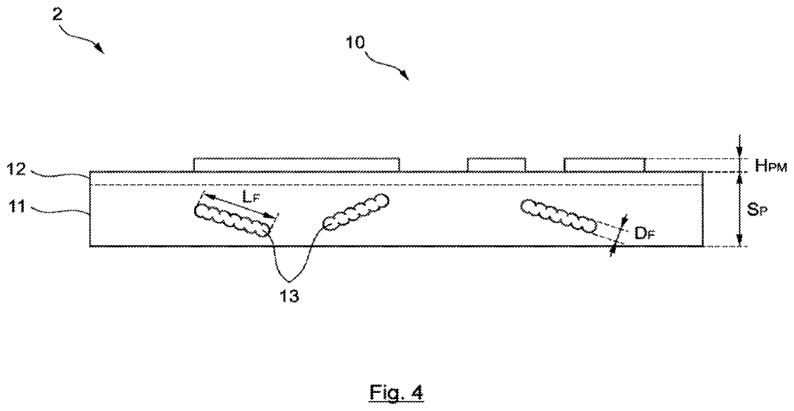

FIG. 4 shows a side view of an embossed barrier paper.

The plan view of an embodiment of the roll assembly I according to the invention shown in FIG. 1 has a first embossing roll 3, shown at the upper face of the picture, and a second embossing roll 4, shown at the bottom of the picture. In the embodiment shown, the first embossing roll 3 has a plurality of embossing elements in the form of embossing elevations 7. These have different shapes and sizes, with the embossing elevations on their upper face each having circumferential edges 6 with a minimum radius R_{K} of 1 μm to 1000 μm. In a corresponding manner, the second embossing roll 4 in the embodiment shown has a plurality of embossing elements in the form of recesses 9. These also have different shapes and sizes, which, however, are complementary to the embossing elevations 7 of the first embossing roll 3. The embossing elements shown each have a width Bp in the circumferential direction Y of at least 0.1 mm and a length L_{P} in the axial direction X of at least 0.1 mm. The recesses 9 also each have circumferential edges 6 with a minimum radius R_{K} of 1 μm to 1000 μm on the plane of the roll surface 8. Both embossing rolls 3, 4 have a surface roughness R_{Z} of 1 to 50 μm. Both rolls 3, 4 are arranged in the axial direction X to each other in such a way that they form a nip 5 between them. This means that both embossing rolls 3, 4 are arranged parallel to each other and aligned with each other in such a way that, with an adjustable roll adjustment, the embossing elevations 7 can engage in the corresponding complementary recesses 9 when a barrier paper 2 is fed through the nip 5. Both embossing rolls 3, 4 are driven in opposite rotation directions Y.

FIG. 2 illustrates a detailed view of a recess 9 in an embossing roll 4 designed as a female die, as shown in FIG. 1. The recess 9 shown has an embossing depth T_{P} of up to 200 μm in the radial direction Z of the embossing roll 4 and a length L_{P} of at least 0.1 mm in the axial direction X, wherein the side walls of the recess are perpendicular to the roll surface 8. It can be seen that the edge 6 surrounding the recess 9 on the plane of the roll surface 8 with the minimum radius R_{K} of I um to 1000 μm provides a relatively smooth transition between the side walls of the recess 9 and the roll surface 8. In contrast, the edge at the base of the recess has a sharper radius.

FIG. 3 shows a detailed view of an embossing elevation 7 of the embossing roll 3 designed as a male die from FIG. 1. The embossing elevation 7 shown has an embossing height Hp of up to 200 um in the radial direction Z of the embossing roll 3 and a length L_{P} of at least 0.1 mm in the axial direction X, wherein the flanks of the embossing elevation 7 are aligned perpendicular to the roll surface 8 as in the recess 9 in FIG. 2. The embossing elevation 7 has a flat upper face. It can be seen that the edge 6 surrounding the embossing elevation 7 on its upper face 7 with the minimum radius R_{K} of 1 μm to 1000 μm also provides a relatively smooth transition between the flanks of the embossing elevation 7 and the upper face of the embossing elevation 7. In contrast, the edge surrounding the embossing elevation 7 on the plane of the roll surface 8 has a sharper radius on the lower side of the embossing elevation 7.

FIG. 4 shows a side view of a barrier paper 2 embossed by means of the method according to the invention. This has a paper layer 11 and a barrier layer 12 lying above it. The paper layer 11 has a plurality of paper fibers 13 which have a fiber length L_{F} of up to 3 mm and a fiber thickness D_{F} of up to 100 μm. The combined thickness or paper thickness S_{P} of the barrier paper 2 consisting of paper layer 11 and barrier layer 12 is between 20 μm and 500 μm. On the upper face of the barrier paper 2, i.e. on the side of the barrier layer 12, the barrier paper 2 has an embossed pattern 10 which, as shown, is formed from a plurality of individual elements spaced apart from one another in the axial direction X. The height H_{PM} of the embossed pattern is up to 50 μm.

The features of the invention disclosed in the above description, in the figures and in the claims can be essential for the implementation of the invention both individually and in any combination.

### LIST OF REFERENCE NUMERALS

1 roll assembly
2 barrier paper
3 first embossing roll
4 second embossing roll
5 nip
6 edge
7 embossing elevation
8 roll surface
9 recesses
10 embossed pattern
11 paper layer
12 barrier layer
13 paper fibers
X axial direction
Y circumferential direction
Z radial direction
H_{P} embossing height
H_{PM} height of embossed pattern
T_{P} embossing depth
L_{P} length of the embossing element
B_{P} width of the embossing element
D_{F} fiber thickness
L_{F} fiber length
R_{K} edge radius
R_{Z} mean roughness
S_{P} paper thickness

1. A roll assembly for producing non-destructively embossed barrier paper for air-tight and water vapor-tight sealing of packages, in particular for use as an inner package, comprising:
a first embossing roll
and a second embossing roll
wherein a nip for feeding through and embossing the barrier paper is formed between the first embossing roll and the second embossing roll
wherein at least one of the embossing rolls has a plurality of embossing elements,
wherein the embossing elements have on their upper face, an edge surrounding the embossing element with an edge radius (R_{K}) of 1 μm to 1000 μm.

2. The roll assembly according to claim 1, wherein the at least one embossing roll having the plurality of embossing elements is designed as a male die and the embossing elements extend away from the roll surface as embossing elevations

3. The roll assembly according to claim 1, wherein the at least one embossing roll having the plurality of embossing elements is designed as a female die and the embossing elements extend into the roll surface as recesses

4. The roll assembly according to claim 1, wherein the backing roll of the embossing roll having the plurality of embossing elements has a smooth roll surface without embossing elements, wherein the roll surface of the backing roll is made of steel or of an elastic material, such as rubber, for example.

5. The roll assembly according to claim 2, wherein the backing roll of the embossing roll having the plurality of embossing elevations is designed as a female die, wherein the backing roll has a plurality of recesses formed in the roll surface which are arranged complementarily to the embossing elevations extending away from the roll surface.

6. The roll assembly according to claim 3, wherein the backing roll of the embossing roll having the plurality of recesses is designed as a male die, wherein the backing roll has a plurality of embossing elevations facing away from the roll surface, which are arranged complementarily to the recesses extending into the roll surface.

7. The roll assembly according to claim 1, wherein the embossing height (H_{P}) and/or embossing depth (T_{P}) of the embossing elements is up to 200 μm.

8. The roll assembly according to claim 1, wherein the first and/or the second embossing roll have/has an average surface roughness (R_{Z}) of 1 to 50 μm.

9. The roll assembly according to claim 1, wherein the embossing elements in an axial direction (X) of the embossing roll each have a length (L_{P}) of greater than 0.1 mm.

10. The roll assembly according to claim 1, wherein the embossing elements in a circumferential direction (Y) of the embossing roll each have a width (B_{P}) of greater than 0.1 mm.

11. A method for producing non-destructively embossed barrier paper for air-tight and water vapor-tight sealing of cigarette packages, in particular for use as an inner liner, with a roll assembly according to claim 1, comprising the steps:
feeding a barrier paper web through the nip of the roll assembly;
forming an embossed pattern in the barrier paper as the barrier paper web is fed through the nip

12. The method according to claim 11, wherein the barrier paper has a fiber thickness (D_{F}) of up to 100 μm.

13. The method according to claim 11, wherein the barrier paper has a fiber length (L_{F}) of up to 3 mm.

14. The method according to claim 11, wherein the paper thickness (S_{P}) of the barrier paper is 20 μm to 500 μm.

15. The method according to claim 11, wherein the embossed pattern has an embossing height (H_{PM}) of up to 50 μm.
